(19) United States
(12) Patent Application Publication
(10) Pub. No.: US 2009/0294075 A1
(43) Pub. Date: Dec. 3, 2009

(54) Play structure assembly comprising connectable sheet panels

(76) Inventor: Katherine H.P. Huck, Princeton, MA (US)

Correspondence Address: Robert M. Amici, 31 Fosgate Road, Berlin, MA, 01503, US

(21) Appl. No.: 12/454,917

(22) Filed: May 26, 2009

Related U.S. Application Data
(60) Provisional application No. 61/128,995, filed on May 27, 2008.

(51) Int. Cl. A63H 33/10; E06B 9/00

(52) U.S. Cl. 160/127; 160/382; 29/428

(57) ABSTRACT

The present invention relates to a play structure assembly comprising two or more flexible sheet panels having a plurality of loops, edge connectors, and interior connectors attached thereto. At least one edge connector of one flexible sheet panel is removably attached to at least one interior connector of an adjacent flexible sheet panel, thereby forming the play structure assembly. Play structures formed using these play structure assemblies, as well as methods to form them, are also disclosed.

### CROSS-REFERENCE TO RELATED APPLICATIONS

This patent application claims the benefit of U.S. Provisional Patent Application No. 61/128,995, filed May 27, 2008.

### BACKGROUND OF THE INVENTION

1. Field of the Invention

The present invention relates to a play structure assembly comprising connectable sheet panels that can be used to form play areas such as forts and tents for children.

2. Description of the Related Art

A variety of different types of play structures are known that can be erected to form a shaped play area for children. Typically such structures are self-supporting, meaning that they comprise a structural means by which the assembly can hold its own shape. For example, U.S. Pat. Nos. 6,071,174 and 6,168,495 describes portable child amusement and educational centers that comprise a tent having flexible walls supported by a frame. In addition, U.S. Pat. No. 6,014,982 relates to a pyramidal tent-like structure comprising a pair of continuous flexible support members or rods that can be bent in a semi-circular configuration to form the play structure. Also, U.S. Pat. No. 3,960,161 describes a portable structure that can be used to form a tent which comprises a continuous loop of a flexible coilable resilient material as a support for the structure. Other types are also known. However, self-supporting structures are typically not compact or easily assembled and disassembled, particularly by a child.

Non-self supporting play structures are also known. For example, U.S. Pat. No. 5,069,623 describes an educational play structure comprising a flexible panel having four side panels that can be mounted on a card table to be used to form an enclosure for children. The side panels are releasably connected to each other. Also, a commercially available product includes sections of flexible sheet of colorful fabric that, in combination with rope and clips, can be used to form a play structure such as a tent of fort. However, these structures require specific devices (such as a card table or a strung rope) for forming the play structure and cannot be used more generally for forming such structures anywhere.

Therefore, there is a need to provide a play structure assembly that can be easily used by a child to create variably shaped play areas in a wide variety of locations.

### SUMMARY OF THE INVENTION

The present invention relates to a play structure assembly comprising two or more flexible sheet panels. Each panel has two opposing surfaces, a corner loop fixedly attached to at least one corner, at least one edge connector fixedly attached to at least one edge, and at least one interior connector fixedly attached to at least one surface. At least one edge connector of one flexible sheet panel is removably attached to at least one interior connector of an adjacent flexible sheet panel, forming the play structure assembly. The present invention further relates to a play tent formed using the disclosed play structure assembly.

### BRIEF DESCRIPTION OF THE DRAWINGS

FIG. 1a-1e show various examples of types of loops that can be used for the play structure assembly of the present invention.

FIG. 2 and FIG. 3 show specific examples of flexible sheet panels of the play structure assembly of the present invention.

FIG. 4 and FIG. 5 show specific examples of forming the play structure assembly of the present invention.

FIG. 6, FIG. 7, FIG. 8, and FIG. 9 show specific examples of the play structure assembly of the present invention.

### DETAILED DESCRIPTION OF THE INVENTION

The present invention relates to a play structure assembly that can be used to form play areas for a child having multiple and changeable shapes.

The play structure assembly of the present invention comprises two or more flexible sheet panels having loops and connectors attached to specifically chosen locations, described in more detail below. The flexible sheet panels may have any desired polyhedral shape, including, for example, rectangular, square, or hexagonal. Preferably, the panels are either square or rectangular. The panels may be prepared using any flexible material known in the art, (that is, a material that may be readily flexed, bent, rolled, or folded), preferably a soft fabric that is both durable and easy to clean, such as fleece, nylon, polyester, or cotton. The panels may also be a microfibrous material, such as polynylon, or a polyester-nylon blend.

The size of the panels can be varied depending on the intended use. For example, when a flexible sheet panel is square or rectangular, the area of the panel may be between about 1 square feet and about 50 square feet, preferably between about 4 square feet and about 30 square feet, and more preferably between about 6 square feet and about 20 square feet. Furthermore, a panel may have at least one side having a length of between about 1 foot and about 6 feet, preferably between about 2 feet and about 5 feet. As an example, the play structure assembly comprises two or more flexible sheet panels, wherein at least one panel is square, having edges of length between about 2 and about 3 feet, or is rectangular, having one edge of length between about 2 and about 3 feet and one edge between about 4 and about 5 feet. Panels of this size are particularly suitable for handling by small children. Preferably each of the panels is the same size and shape.

Each flexible sheet panel has two opposing surfaces, and each surface may be the same or different. Also, the panels may be one layer of material or multiple layers of the same or different materials. For example, each of the flexible sheet panels may be a single layer of a colored material with each surface being the same. Also, this single layer of material may have an image or design imprinted or stitched into one surface, such as an image of the outside of fort or house. Thus, the flexible sheet panels may comprise a single layer of material having the same or different opposing surfaces. Also, two layers of materials may be used, resulting in a flexible sheet panel having different opposing surfaces (if the two materials differ) or same opposing surfaces (if the two materials are the same). At least one of the flexible sheet panels may further comprise pockets or pouches attached to at least one of the surfaces, and these may be either permanent or detachable. Also, portions of the panels may comprise various slits, flaps, or cut-out sections, in order, for example, to form a door or window section.

The flexible sheet panels of the play structure assembly of the present invention further comprise a corner loop, strap, or flexible handle attached, preferably fixedly attached, to at least one corner. By “fixedly attached”, is meant that the corner loop is affixed to the corner and cannot be easily removed. Any method of fixing may be used, including, for example, sewing, gluing, or permanently adhering. Preferably, at least one panel comprises a corner loop attached, preferably fixedly attached, to each corner, and more preferably, each panel comprises corner loops fixedly attached to each corner. As used herein, the term “loop” or “strap” or “handle” refers to a narrow segment of material forming a closed shape that is capable of being wrapped around or over an object, such as the back of a chair or door knob. The corner loop may be any size and is preferably between about 1 inch and about 6 inches in diameter, more preferably between about 1 inch and about 4 inches in diameter. Also, the corner loop may be any width, such as between about 0.5 inches to about 2 inches, including between about 1 inch and about 1.5 inches.

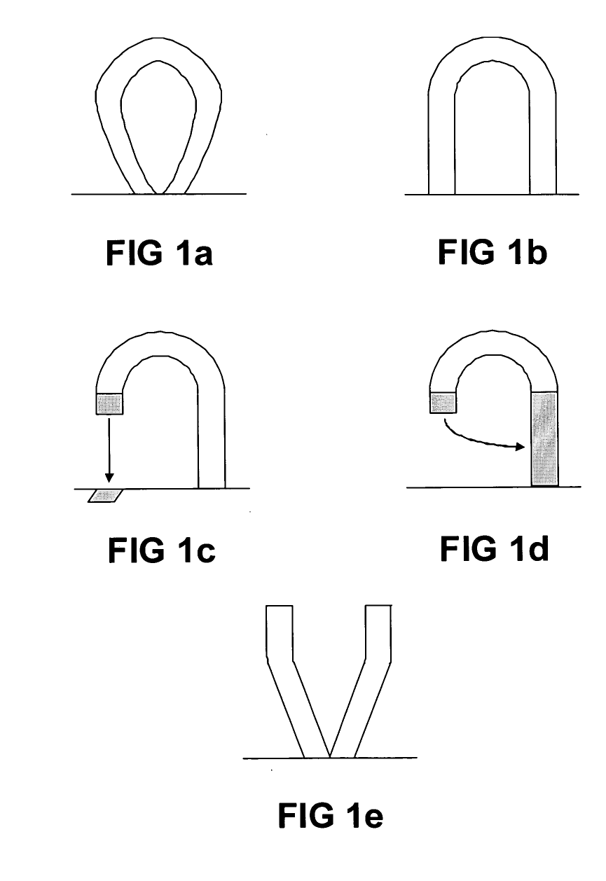

Examples of types of corner loops are shown in FIG. 1a-1e. Thus, for example, the corner loop may comprise one loop segment, such as a narrow strip of material, having two ends, wherein both ends are fixedly attached to the corner of the flexible sheet panels, examples of which are shown in FIG. 1a and FIG. 1b. Each end may be attached to the same location on the flexible sheet panels (as in FIG. 1a) or may be attached in close proximity to each other (as in FIG. 1b). Such corner loops would be considered to be fixed dimension loops, meaning that, once formed, the diameter of the loop cannot be changed. For such corner loops, any rigid or non-elastic material known in the art may be used, including, for example, various synthetic or natural fabrics (such as nylon), ropes, or cords.

The corner loops attached to the flexible sheet panels may also have a diameter that can be changed or adjusted, examples of which are shown in FIG. 1c, FIG. 1d, and FIG. 1e. Such variable dimension loops provide greater flexibility in the use of the play structure assembly of the present invention, enabling it to be used to form a play area for a child having multiple and changeable shapes and designs in a wide variety of locations, and are therefore preferred. For example, the variable dimension loop may comprise one loop segment, such as a narrow strip of material, having two ends, wherein one end is fixedly attached to the corner of the flexible sheet panel and the other end is configured to attach or connect to either an attachment site on the flexible sheet panels near the fixed end (as in FIG. 1c) or along the length of the loop segment (as in FIG. 1d). The arrow in these figures shows how the loop is formed by attaching the configured end to the attachment site. Such a corner loop can be made of any material comprising an adhesive or adherable section, such as Velcro. In addition, the corner loop may comprise two loop segments, such as two narrow strips of material, each having two ends, wherein one end of each loop segment is fixedly attached to the same or proximal locations on the flexible sheet panels and wherein the other ends of each loop segment are configured to connect together, thereby forming the corner loop (as shown in FIG. 1e). The loop may be formed, for example, by tying the unattached ends together or by adhering the unattached end of one loop segment to the unattached end of the other loop segment using an adhesive or adherable section, such as Velcro. Also, the variable dimension loop may be elastic, thereby being able to stretch over an object or around an object. Other combinations are possible, including, for example, elastic loop segments fixedly attached on one end to the corner of the flexible sheet panel and the other end configured to adhere or tie together. In these ways, the dimension of the loop can be changed, and the play structure assembly may be more securely attached to an object to form a variety of different types of play areas.

The flexible sheet panels also comprise at least one edge connector that is attached, preferably fixedly attached, to at least one edge. The number and location of these connectors will depend on the size and shape of the flexible sheet panel. For example, the panels may comprise at least two edge connectors along at least one edge, such as from 2 to 10 edge connectors. Preferably, the panels each comprise from 2 to 4 edge connectors along each of the edges. The edge connectors may be attached anywhere along an edge but are preferably equally spaced along the length of each of the edges of the panels.

The flexible sheet panels further comprise at least one interior connector attached, preferably fixedly attached, to at least one surface, preferably to the same surface. As with the edge connectors, the number and location of the interior connectors will depend on the size and shape of the flexible sheet panel. For example, the interior connectors may be anywhere on the surface of the panels, but are preferably adjacent to each of the edges of the panels, including, for example, in a configuration that is parallel to each of the edges. Also, at least one of the interior connectors can be in a position adjacent to at least one of the edge connectors, described above. Preferably, the interior connectors are adjacent to the edge connectors—that is, the flexible sheet panels preferably comprise edge connectors fixedly attached along each edge and interior connectors each fixedly attached to the same surface and each are adjacent to each of the edge connectors. The number of interior connectors can also be varied depending on the number of edge connectors. For example, the panels may comprise at least two interior connectors adjacent to each of the edges, such as from 2 to 10 interior connectors, and more preferably from 2 to 4 interior connectors. In addition, the flexible sheet panels may comprise interior connectors fixedly attached to the surface at a position adjacent to at least one corner loop and preferably adjacent to each corner loop. As described in more detail below, such an arrangement provides flexibility in forming the play structure assembly of the present invention.

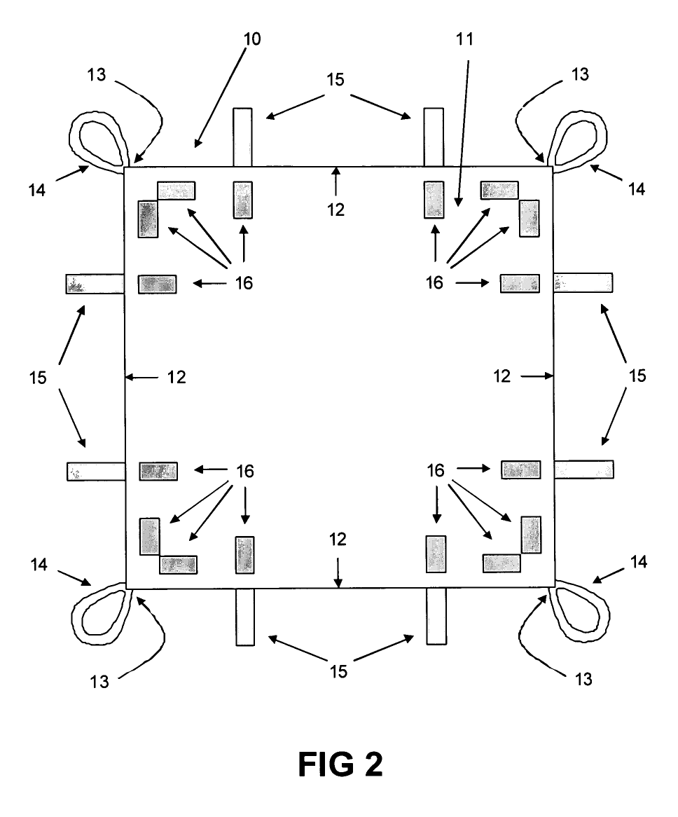

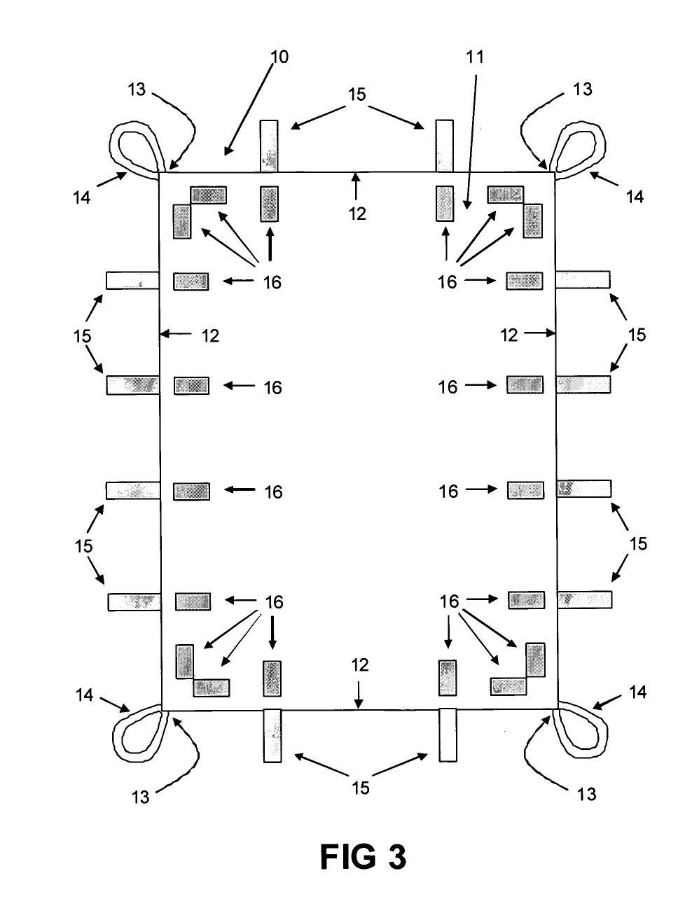

FIG. 2 and FIG. 3 each show specific examples of the flexible sheet panels used to form the play structure assembly of the present invention. These figures are meant to further clarify the present invention and are intended to be only exemplary in nature.

In FIG. 2, the flexible sheet panel 10 is square and comprises one surface 11, four edges 12, and four corners 13. The opposing surface is behind the schematic and is therefore not shown. Either surface may comprise a printed image or color, although, for simplicity, none is shown. To each corner is attached a corner loop 14. Also, two edge connectors, 15, are shown fixedly attached to each edge 12, and these are equally spaced apart. In addition, two interior connectors, 16, are shown fixedly attached to the surface 11 along each edge 12, and, as shown, are both adjacent and parallel to each edge 12 and also adjacent to each edge connector 15. Furthermore, the flexible sheet panel 10 also comprises two interior connectors fixedly 16 fixedly attached to the surface 11 adjacent to each corner 13. While, the flexible sheet panel shown in FIG. 2 has 8 edge connectors 15 and 16 interior connectors 16, it will be recognized that additional connectors may be used depending on the length of each side in order to provide greater flexibility for forming the desired play structure assembly.

Also, the number of connectors can change depending on the shape of the flexible sheet panel. For example, FIG. 3 shows an example of a rectangular flexible sheet panel 10 that comprises one surface 11, four edges 12, and four corners 13, each having attached a corner loop 14. Also, two edge connectors, 15, are shown fixedly attached to each of the shorter edges 12 while four edge connectors, 15, are shown fixedly attached to each of the longer edges 12. For both edges, the connectors are equally spaced apart. Likewise, two interior connectors, 16, are shown fixedly attached to the surface 11 along each of the shorter edges 12, and four are shown fixedly attached to the surface 11 along each of the longer edges 12. As shown, these connectors are also both adjacent and parallel to each edge 12 and also adjacent to each edge connector 15. This flexible sheet panel 10 also comprises two interior connectors fixedly 16 fixedly attached to the surface 11 adjacent to each corner 13. Thus, in this figure, 12 edge connectors 15 and 20 interior connectors 16 are shown.

The edge connectors and interior connectors are configured to be removably attached to each other. By “removably attached” is meant that the connectors can be attached or connected to each other temporarily and, if desired, subsequently also be detached or disconnected from each other. Thus, at least one edge connector of one flexible sheet panel can be attached to at least one interior connector of an adjacent flexible sheet panel and can subsequently be removed or detached from each other. Any known method or design may be used to temporarily attach the edge connectors and interior connectors to each other. For example, either or both of these connectors may comprise an adhesive strip that may be used to stick or adhere to each other and can then be later removed. Any material comprising an adhesive or adherable section may be used, including tacky materials or materials such as Velcro. In addition, two separate components may be used to adhere an edge connector to an interior connector, or vice versa.

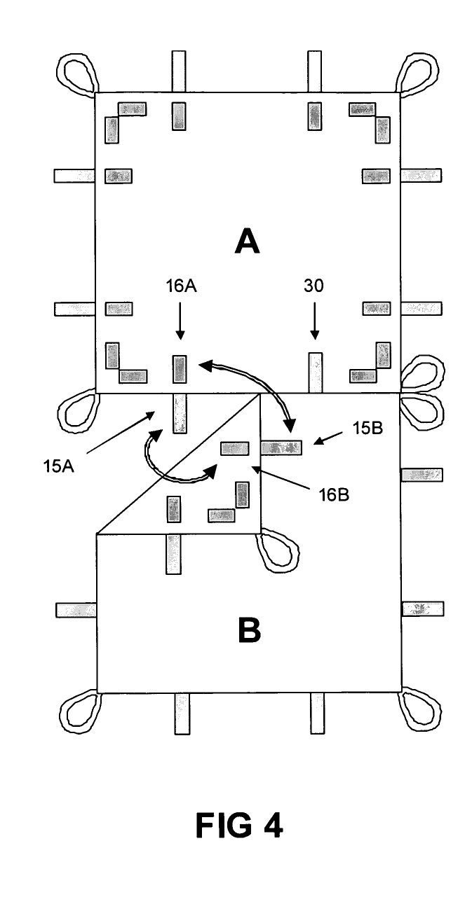

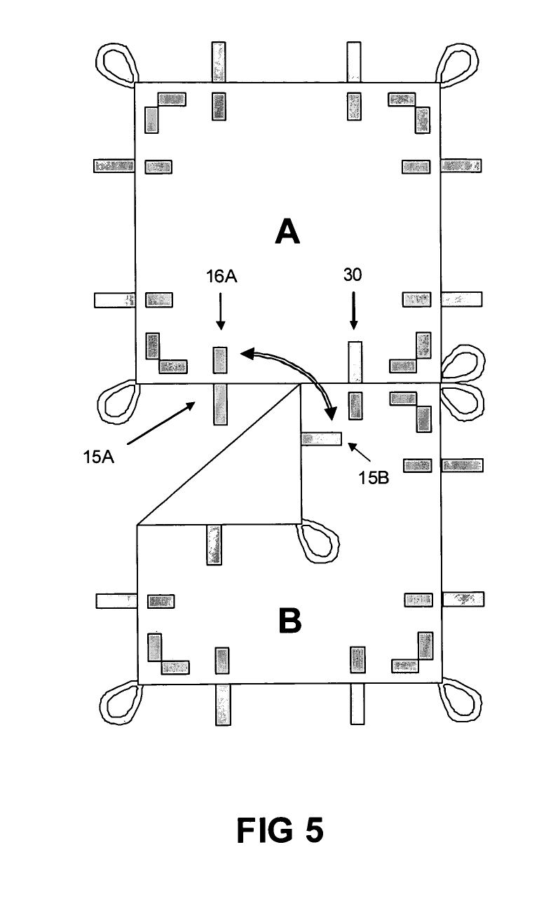

FIG. 4 and FIG. 5 show specific examples of how these connectors may be removably attached. In particular, in FIG. 4, two flexible sheet panels, A and B, are shown, and these are attached to each other at connection 30. A second connection is also shown being formed by attaching the edge connector of panel A (15A) to the interior connector of panel B (16B) and simultaneously attaching the edge connector of panel B (15B) to the interior connector of panel A (16A). This is represented by the two double-headed arrows in FIG. 4. In FIG. 5, a different way to combine two panels is shown. In particular, two flexible sheet panels, A and B are attached at connection 30 and a second connection is being formed by attaching the edge connector of panel B (15B) to the interior connector of panel A (16A), which is represent by the double-headed arrow in FIG. 5. Edge connector 15A of panel A is not used since the interior connector of panel B (16B), not shown, is on the opposing surface. For both of these examples, the connections that are formed can also be disconnected by removing the edge connectors from the interior connectors.

By attaching edge connectors of one flexible sheet panel to interior connectors of adjacent flexible sheet panels, a play structure assembly can be formed. Thus, the present invention further relates to a method of forming a play structure assembly comprising the steps of i) providing two or more flexible sheet panels described above and removably attaching at least one edge connector of one flexible sheet panel to at least one interior connector of an adjacent flexible sheet panel. The flexible sheet panels can therefore be considered building tools for forming the play structure assembly.

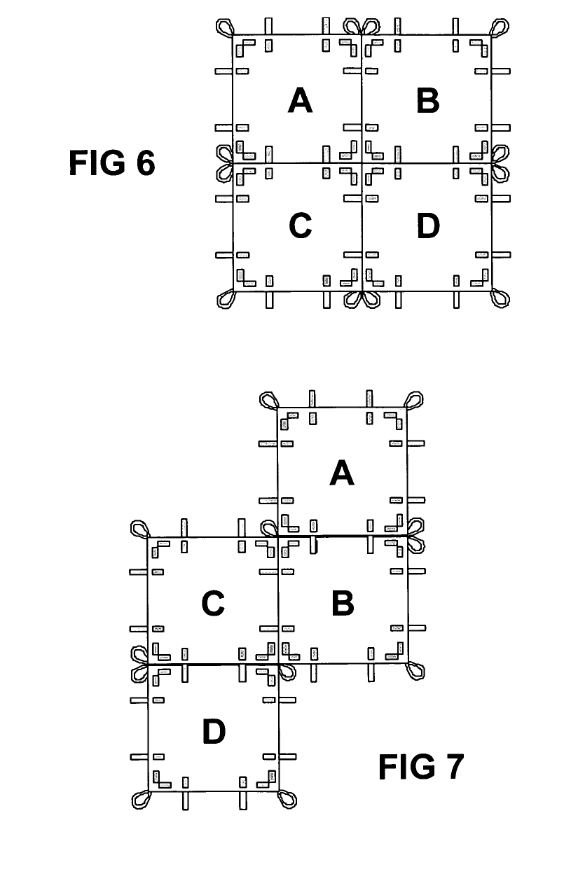

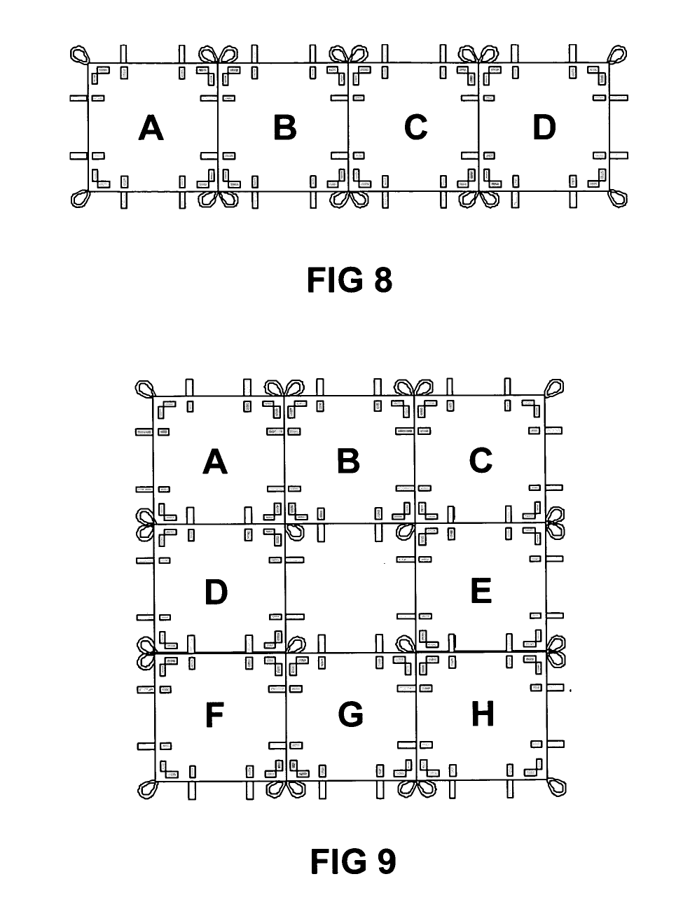

Due to the positioning of the edge connectors and interior connectors, as well as the attachment method used, play structure assemblies having a wide variety of designs can be created. Specific examples are shown in FIG. 6, FIG. 7, FIG. 8, and FIG. 9. In particular, FIG. 6, FIG. 7, and FIG. 8 each show different play structure assemblies that can be formed using only four of the flexible sheet panels described above (panels A, B, C, and D). Other shapes are also possible. Also, FIG. 9 shows an example of a larger play structure assembly that can be formed using eight flexible sheet panels (panels A, B, C, D, E, F, G, and H), and, again, other shapes are also possible. Furthermore, such assemblies can be added to with additional flexible sheet panels in order to create more complicated shapes, or, alternatively, these assemblies can be disassembled and reassembled into different sizes and shapes. Also, since the flexible sheet panels can be readily attached or unattached, the play structure assemblies can be formed with ease by children of many different ages and can be used to form play structures, described below. Play structure assemblies having 3-dimensional shapes can also be formed, such as mazes or tunnels. This flexibility in design provides a significant improvement over typical play structure assemblies known in the art.

The play structure assembly of the present invention is non-self supporting, meaning it does not comprise a structural means by which it can hold a defined shape. Rather, this structure is compact and portable, and can be rolled up for easy storage. Since this assembly is able to lie flat, it can be used as both a play mat and as a decorative wall hanging. Furthermore, the play structure assembly can be used to form a play structure or play area having a defined shape, such as a play tent, fort, or house. The corner loops of the play structure assembly may be hooked onto a wide variety of household items, including furniture, such as the backs of chairs, handrails, and door knobs. Any or all of the corner loops of any or all of the flexible sheet panels may be used, producing a wide variety of play structures or play areas having different shapes and sizes. Since, the use of a large number of flexible sheet panels to form the play structure assembly results in some of the corner loops being on the inner surfaces of the play structure assembly, there is no need for additional loops to be attached to the flexible sheet panels themselves. Thus, in a preferred embodiment, the flexible sheet panels do not comprise interior loops attached to either opposing surface. The corner loops of the flexible sheet panels may be used as interior loops for the play structure assembly, and these “inner” corner loops can also provide the play structure assembly with multiple means to design and create a wide variety of different types of play areas quickly and easily. For example, by utilizing these “inner” corner loops, a play area can be formed having a roof and multiple sides, similar to fort or play house. As a specific example, the play structure assembly shown in FIG. 9 can be used to form a tent with an opening in the roof. The play structure of the present invention can then be readily taken down and reused to form another different play structure or play area, even in a different location.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A play structure assembly comprising two or more flexible sheet panels, wherein each flexible sheet panel comprises:
a) two opposing surfaces and a plurality of edges and corners,
b) a corner loop fixedly attached to at least one corner,
c) at least one edge connector fixedly attached to at least one edge, and
d) at least one interior connector fixedly attached to at least one surface; and wherein at least one edge connector of one flexible sheet panel is removably attached to at least one interior connector of an adjacent flexible sheet panel.

2. The play structure assembly of claim 1, wherein the flexible sheet panels are rectangular or square.

3. The play structure assembly of claim 1, wherein at least one flexible sheet panel is rectangular and at least one flexible sheet panel is square.

4. The play structure assembly of claim 1, wherein at least one flexible sheet panel comprises a corner loop fixedly attached to each corner.

5. The play structure assembly of claim 1, wherein each flexible sheet panel comprises a corner loop fixedly attached to each corner.

6. The play structure assembly of claim 1, wherein at least one corner loop is a variable dimension loop.

7. The play structure assembly of claim 6, wherein the variable dimension loop comprises two loop segments, each segment having one end fixedly attached to the flexible sheet and one end configured to connect to the other loop segment to form the corner loop.

8. The play structure assembly of claim 7, wherein the loop segments are configured to tie together to form the loop.

9. The play structure assembly of claim 7, where the loop segments are configured to attach to each other to form the loop.

10. The play structure assembly of claim 6, wherein the variable dimension loop is elastic.

11. The play structure assembly of claim 1, wherein each flexible sheet panel comprises at least two edge connectors fixedly attached to each edge.

12. The play structure assembly of claim 11, wherein each flexible sheet panel comprises two to four edge connectors.

13. The play structure assembly of claim 11, wherein the edge connectors are equally spaced on each edge.

14. The play structure assembly of claim 1, wherein each flexible sheet panel comprises at least two interior connectors fixedly attached to one surface.

15. The play structure assembly of claim 14, wherein each flexible sheet panel comprises two to four interior connectors.

16. The play structure assembly of claim 14, wherein the interior connectors are fixedly attached to the surface adjacent to each of the edges of the flexible sheet panel.

17. The play structure assembly of claim 16, wherein the interior connectors are fixedly attached to the surface at a position adjacent to each exterior connector of the flexible sheet panel.

18. The play structure assembly of claim 17, further comprising interior connectors fixedly attached to the surface at a position adjacent to each corner loop.

19. A play structure formed using a play structure assembly comprising two or more flexible sheet panels, wherein each flexible sheet panel comprises:
a) two opposing surfaces and a plurality of edges and corners,
b) a corner loop fixedly attached to at least one corner,
c) at least one edge connector fixedly attached to at least one edge, and
d) at least one interior connector fixedly attached to at least one surface; and wherein at least one edge connector of one flexible sheet panel is removably attached to at least one interior connector of an adjacent flexible sheet panel.

20. A method of forming a play structure assembly comprising the steps of:
i) providing two or more flexible sheet panels, wherein each flexible sheet panel comprises:
a) two opposing surfaces and a plurality of edges and corners,
b) a corner loop fixedly attached to at least one corner,
c) at least one edge connector fixedly attached to at least one edge, and
d) at least one interior connector fixedly attached to at least one surface;
and
ii) removably attaching at least one edge connector of one flexible sheet panel to at least one interior connector of an adjacent flexible sheet panel.
